(19) United States
(12) Patent Application Publication
(10) Pub. No.: US 2026/0221652 A1
(43) Pub. Date: Jul. 30, 2026

(54) Controllable Reflector

(71) Applicant: Siemens Aktiengesellschaft, Munchen (DE)

(72) Inventors: Janos Gila, Mödling (AT); Andreas HOFMANN, Wien (AT); Lukas Walter MAYER, Wien (AT); Martin SCHIEFER, Poelten (AT)

(21) Appl. No.: 19/147,557

(22) PCT Filed: Dec. 21, 2023
(86) PCT No.: PCT/EP2023/087280

§ 371 Date: Jul. 11, 2025

(51) Int. Cl. H01Q 3/46; H01Q 3/02

(52) U.S. Cl. CPC H01Q 3/46; H01Q 3/02

(57) ABSTRACT

A controllable reflector includes an electronically controllable reflector device that has an antenna structure having controllable antenna elements, an antenna control device for actuating the antenna elements and a connected mechanical orientation device having an orientation control device, wherein the mechanical orientation device is configure to orient the electronically controllable reflector device mechanically in space, and where the antenna control device and the orientation control device in combination are configurable such that a variable directional characteristic of the reflector for reflecting an incident signal with a variable direction of incidence with respect to the reflector (SR) can be adjusted.

### CROSS-REFERENCE TO RELATED APPLICATIONS

This is a U.S. national stage of application No. PCT/EP2023/087280 filed 21 Dec. 2023. Priority is claimed on European Application No. 23151400.1 filed 12 Jan. 2023, the content of which is incorporated herein by reference in its entirety.

### BACKGROUND OF THE INVENTION

### 1. Field of the Invention

The invention relates to a controllable reflector.

### 2. Description of the Related Art

A controllable reflector has a number of antenna elements each of which receives a high-frequency signal, reflects it at an integrated electronically controllable element and re-radiates this reflected signal.

The electronically controllable element in an antenna element is actuated by a control module that uses magnitude information and phase information as a control signal to influence the reflection properties of the antenna element.

For example, a controllable reflector can be a binary controllable planar antenna array in which the phase of the reflection coefficient can be influenced by actuating a diode connected to an antenna element of the array in a binary manner. Each antenna element clearly has its own reflector element, such as a diode. Instead of a diode, it is also possible for a transistor, a switch or a phase shifter to be used.

A controllable reflector usually consists of a plurality of antenna elements, where the size and geometry of the antenna elements are often the same and the geometric arrangement on the surface follows a special rule, namely, for example, round copper elements with a spacing of 0.8 times the wavelength.

The quality (performance) of this controllable reflector can be described with the “relaying gain”. To achieve high gain, the controllable reflector comprises many basic or antenna elements, often more than 1000.

A controllable reflector is usually limited to a rather narrow range in which the directional characteristic can be adjusted.

In contrast, a mechanically pivoting reflector has a rather large pivoting range, but the precision required for adjusting the directional characteristic can only be achieved with considerable effort, such as that required for reflectors in the micrometer and millimeter wave range. Mechanical adjustment is also considerably slower than electronic adjustment.

U.S. Pat. No. 4,198,640 A discloses an electronically controllable antenna with electronically adjustable antenna characteristic.

Publication WO 2022/186815 A1 discloses a system for configurating mobile radio base stations, which provides a static operation after an initial alignment.

### SUMMARY OF THE INVENTION

It is the object of the invention to provide a controllable reflector which, when used, can be adjusted or aligned in space and over a wide adjustment range in a particularly simple manner.

This and other objects and advantages are achieved in accordance with the invention by a controllable reflector which comprises an electronically controllable reflector unit, comprising an antenna structure with controllable antenna elements and an antenna control unit for actuating the antenna elements, and a connected mechanical alignment unit with a mechanical alignment control unit, where the mechanical alignment unit is configured to align the electronically controllable reflector unit mechanically in space, and where the antenna control unit and the alignment control unit can be configured in combination such that it is possible to adjust a variable directional characteristic of the reflector for reflecting an incident signal with a variable direction of incidence with respect to the reflector.

The above-described solution allows particularly precise alignment to be achieved in a simple manner, i.e., rough adjustment by mechanical alignment and fine adjustment by electronic alignment. This makes the controllable reflector easier to handle during installation and in operation.

Furthermore, the common directional characteristic of the reflector can be adjusted particularly precisely and over a wide reflection range.

The combination of mechanical and electronic beam steering can also achieve improved dynamic behavior.

For example, a rapid and at the same time precise change in the variable directional characteristic can be achieved by combining mechanical and electronic beam steering, for example, by compensating for inaccuracies or oscillations caused by the mechanical beam steering by the electronic beam steering.

For example, however, beam steering that is statically fixed over a period of time, which is, for example, due to external influences on the reflector, can be compensated by the electronic beam steering and a particularly stable directional characteristic can be achieved over the period of time.

These influences are taken into account by a embodiment of the invention, where the antenna control unit and the alignment control unit can be configured in combination such that undesired mechanical effects on the reflector, which are caused by a movement of the reflector, are compensated by a sensor that is comprised by the reflector and that is configured to capture movement data relating to the undesired movement, via a corresponding control using the movement data.

In the present context, an antenna element comprises a controllable reflector element that receives a signal received by the antenna element itself, reflects it in a controllable manner via a control signal and re-radiates it again via the antenna element.

The control module is configured to actuate the respective antenna elements with control signals such that a desired reflection property is achieved by the reflector element and the antenna element itself, and thus, for example, a desired antenna directional characteristic of the controllable reflector is achieved.

A transmitter arranged in a stationary manner in relation to the controllable reflector radiates a transmission signal to the controllable reflector.

If the controllable reflector rotates, then the directional characteristic of the reflector with respect to the transmission signal, i.e., the incident signal for the reflector, behaves like a variable direction of incidence with respect to the reflector.

In one embodiment of the invention, the antenna structure has a surface which, at least in individual points or locations of the surface, follows a shape contour, which is formed as conical, parabolic, pyramidal, hemispherical or funnel-shaped.

The surface of the antenna structure can be assembled from a plurality of components, each of which is planar. These components can be applied and attached to a support structure in a tangential manner so that the components only follow the aforementioned shape contour at one point, the tangent point.

The shape contour can, for example, be formed by a holding structure upon which antenna components with antenna elements are arranged. The points of the shape contour to which the antenna components are attached can form an imaginary contour, which has a conical, parabolic, pyramidal, hemispherical or tunnel-shaped form.

In one embodiment of the invention, the antenna elements each have a round shape. This enables the antenna structure or its components to be manufactured particularly easily and precisely.

In another embodiment of the invention, the antenna control unit comprises an electronic circuit that is configured to actuate the antenna elements by a preset configuration of control signals such that they do not change over a period of more than 10 seconds, preferably more than 1 minute, particularly preferably more than 10 minutes.

As a result, the electronically controllable reflector unit can be manufactured and put into operation more easily and cost-effectively.

In a further embodiment of the invention, the electronically controllable reflector unit has a number of more than 30 antenna elements, preferably more than 100 antenna elements.

The above-described reflector is particularly suitable for larger reflectors as the influence of manufacturing accuracies then increases.

In another embodiment of the invention, the antenna elements are each structured for an operating frequency of more than 20 GHz, preferably more than 30 GHZ and particularly preferably more than 40 GHZ, and preferably the antenna elements have a spacing between them of 0.8 times the wavelength of the operating frequency.

The above-described reflector is particularly suitable for reflectors with operating frequencies in the micrometer and millimeter wave range as the influence of manufacturing accuracies then increases.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below with reference to an exemplary embodiment depicted in the enclosed drawings, in which:

FIG. 1 shows an exemplary embodiment of a controllable reflector in accordance with the invention;

FIG. 3 shows an exemplary embodiment of a circuit carrier with a depiction for a group with a plurality of antenna elements,

FIG. 2 shows an exemplary embodiment of a configuration of the electronically controllable reflector.

### DETAILED DESCRIPTION OF THE EXEMPLARY EMBODIMENTS

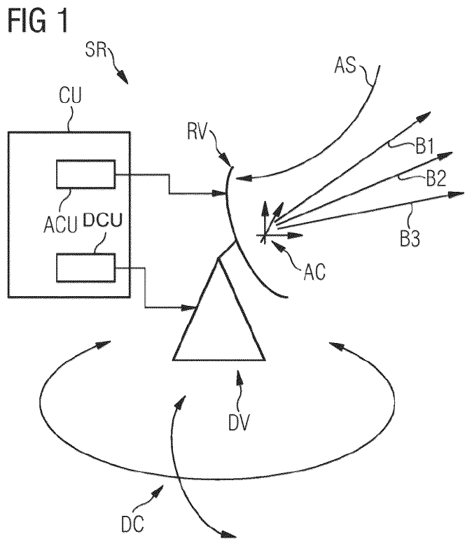

FIG. 1 depicts an exemplary embodiment of a controllable reflector in accordance with the invention SR.

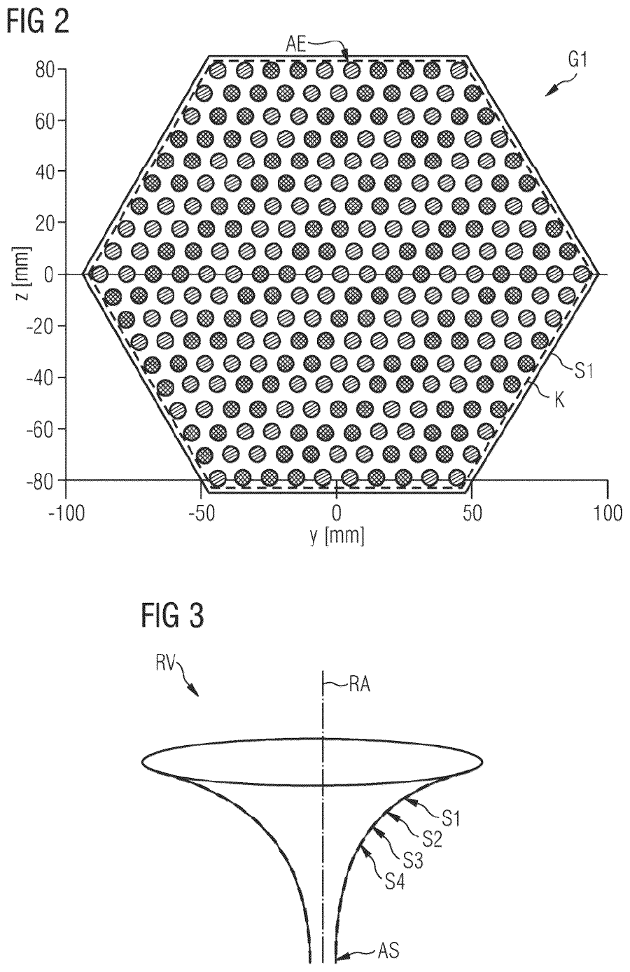

This is an electronically controllable reflector unit RV comprising controllable antenna elements AE (see FIG. 2) on a surface of an antenna structure AS (see FIG. 3) and an antenna control unit ACU for actuating the antenna elements AE.

The electronically controllable reflector unit RV is configured to adjust a directional characteristic for a first coordinate system AC, for example, three-dimensionally in space, which is indicated by the beams B1, B2, B3 in the figure and can, for example, represent the Poynting vector, which characterizes the density and the main direction of energy transport (energy flux density) of an electromagnetic field reflected by the reflector RV.

The beams B1, B2, B3 should be understood to be three possible main directions of the reflected signal.

In application, for example, one of the main directions B1, B2, B3 can be selected electronically by corresponding control signals for the antenna elements AE.

In certain selected embodiments, the reflector is not provided in both the transmit and receive direction or is not provided for all polarizations of the transmitted signal, for example, if an amplifier is used in the antenna elements.

In one specific exemplary embodiment, the antenna control unit ACU can comprise an electronic circuit, which is, for example, configured to actuate the antenna elements AE statically, for example, by a fixed electronic circuit arrangement.

Alternatively, the antenna control unit ACU can comprise an electronic circuit that is configured to actuate the antenna elements AE by a preset configuration of control signals such that they do not change over a period of more than 10 seconds, preferably more than 1 minute, particularly preferably more than 10 minutes. This can simplify the determination and provision of the control signals if an arrangement changes only slowly.

Furthermore, a connected mechanical alignment unit DV with an alignment control unit DCU is comprised.

The mechanical alignment unit DV is configured to align the electronically controllable reflector unit RV mechanically in space.

The mechanical alignment unit DV is configured to align a directional characteristic for a second coordinate system DC, for example, rotatably and pivotably.

The antenna control unit ACU and the alignment control unit DCU can be configured in combination such that a variable directional characteristic of the reflector can be adjusted.

The antenna control unit ACU can, for example, be electrically connected to the individual circuit carriers S1, S2, S3, S4 and their antenna elements AE via digital control lines and, for example, be actuated with a binary control signal. The antenna control unit ACU is configured to actuate each of the antenna elements AE with individual magnitude/amplitude information and/or phase information.

For example, an amplifier can be integrated into each antenna element AE in order to re-radiate the signal in amplified form.

This common actuation can occur with the aid of a control unit CU.

The antenna control unit ACU and the alignment control unit DCU can be configured in combination such that undesired mechanical effects on the reflector SR can be compensated via a corresponding control using the movement data.

The undesired mechanical effects can be caused by a movement of the reflector SR and captured by a sensor.

The sensor can be comprised by the reflector SR and can be configured to capture movement data relating to the undesired movement.

The undesired movement of the reflector can, for example, be caused by external influences, such as weather, wind or vibrations, or also, for example, by a rotational movement or oscillation of the reflector SR as a result of the mechanical beam steering of the reflector SR.

A corresponding sensor for capturing the movement data, not shown in the figure, can, for example, be comprised by the antenna control unit ACU and can, for example, be formed by an electronic three-axis acceleration sensor.

FIG. 2 depicts controllable antenna elements AE on a component S1 for an antenna structure in a hexagonal shape K. On the surface of the antenna structure, a first group G1 with a number of circular round antenna elements AE in a planar configuration can be identified on a first circuit carrier S1, such as a planar printed circuit board with a hexagonal contour K. The circuit carrier S1 and antenna elements AE form antenna components S1, S2, S3, S4.

Herein, the antenna elements AE in the first group G1 are arranged such that an imaginary outer contour K of the group G1 encloses its antenna elements AE and forms a substantially hexagonal shape.

FIG. 3 shows an exemplary embodiment of a configuration of the electronically controllable reflector RV.

The electronically controllable reflector RV has a surface of the antenna structure AS which, at least in individual points of the surface, follows a shape contour, which is formed as cylindrical (for example, with a round or hexagonal base area), conical, parabolic, pyramidal, hemispherical or funnel-shaped and is, for example, formed by rotation about an axis of rotation RA.

This example depicts a funnel-shaped holding structure or antenna structure AS, which is formed about an axis of rotation RA.

A plurality of groups, each identical in construction to the first group G1, with round antenna elements AE on the first planar circuit carrier S1 in the form of a printed circuit board with a hexagonal outer contour K, are arranged as antenna components S1, S2, S3, S4 on the surface of a holding structure (not depicted for better clarity), which form the antenna structure AS of an electronically controllable reflector.

The antenna components S1, S2, S3, S4 are each formed by a circuit carrier with antenna elements AE of a respective group arranged thereon.

To mechanically join the groups, the circuit carriers are fixed by the holding structure; this is not depicted in detail in the figure.

The advantages of the aforementioned arrangement with regard to alignment are particularly great/significant if the groups each a number of more than 30 antenna elements AE, preferably more than 100 antenna elements AE.

The advantages of the aforementioned arrangement with regard to alignment are also particularly great/significant if the antenna elements are each structured for an operating frequency of more than 20 GHZ, preferably more than 30 GHZ and particularly preferably more than 40 GHZ, and preferably the antenna elements AE within the respective group have a spacing between them of 0.8 times the wavelength of the operating frequency.

Both advantages add up synergistically for combined dimensioning with regard to the number and operating frequency of the antenna elements AE.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements that perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### LIST OF REFERENCE CHARACTERS

AC Antenna coordinate system
ACU Antenna control unit (“reflector control unit”)
AE Antenna element
AS Antenna structure
B1-B3 Direction of radiation, direction of reflection (“beam”)
CU Control unit of the controllable reflector
DC Alignment coordinate system
DCU Alignment control unit (“direction control unit”)
DV Alignment unit
G1 Group
K Contour
RA Axis of rotation
RV Reflector unit
S1-S4 Circuit carrier with antenna elements, antenna component

1.-7. (canceled)

8. A controllable reflector, comprising:
an electronically controllable reflector unit, comprising an antenna structure with controllable antenna elements;
an antenna control unit for actuating the antenna elements; and
a connected mechanical alignment unit with an alignment control unit, the mechanical alignment unit being configured to mechanically and spatially align the electronically controllable reflector unit;
wherein the antenna control unit and the alignment control unit are configurable in combination such that a variable directional characteristic of the reflector for reflecting an incident signal with a variable direction of incidence with respect to the reflector is adjustable; and
wherein the antenna control unit and the alignment control unit are further configurable in combination such that undesired mechanical effects on the reflector, which are caused by a movement of the reflector, are compensated for by a sensor comprised of the reflector and which is configured to capture movement data relating to the undesired movement, via corresponding control of the electronically controllable reflector unit utilizing the movement data.

9. The reflector as claimed in claim 8, wherein the antenna structure has a surface which, at least in individual points, follows a shape contour, which is formed in a cylindrical, conical, parabolic, pyramidal, hemispherical or funnel-shape.

10. The reflector as claimed in claim 8, wherein the antenna elements each have a round shape.

11. The reflector as claimed in claim 8, wherein the antenna control unit comprises an electronic circuit which is configured to actuate the antenna elements by a preset configuration of control signals such that the antenna elements do not change over a period of more than 10 seconds.

12. The reflector as claimed in claim 11, wherein the antenna elements do not change over a period of more 1 minute.

13. The reflector as claimed in claim 12, wherein the antenna elements do not change over a period of more than 10 minutes.

14. The reflector as claimed in claim 8, wherein the electronically controllable reflector unit has a number of more than 30 antenna elements, preferably more than 100 antenna elements.

15. The reflector as claimed in claim 14, wherein the electronically controllable reflector unit has a number of more than 100 antenna elements.

16. The reflector as claimed in claim 8, wherein the antenna elements are each structured for an operating frequency of more than 20 GHz, and the antenna elements have a spacing between them of 0.8 times a wavelength of frequency of operation.

17. The reflector as claimed in claim 16, wherein the antenna elements are each structured for an operating frequency of more 30 GHz.

18. The reflector as claimed in claim 17, wherein the antenna elements are each structured for an operating frequency of more than 40 GHz.
